(19) United States
(12) Patent Application Publication
(10) Pub. No.: US 2024/0255834 A1
(43) Pub. Date: Aug. 1, 2024

(54) OPTICAL SYSTEM ASSEMBLY FOR A CAMERA DEVICE

(71) Applicant: MOTHERSON INNOVATIONS COMPANY LIMITED, London (GB)

(72) Inventor: Ralf TIEKENHEINRICH, Stuttgart (DE)

(21) Appl. No.: 18/423,934

(22) Filed: Mar. 28, 2024

(30) Foreign Application Priority Data
Jan. 31, 2023 (DE) 10 2023 102 338.1
Mar. 30, 2023 (DE) 10 2023 108 100.4

(51) Int. Cl. G03B 17/12

(52) U.S. Cl. CPC G03B 17/12; G03B 2217/002

(57) ABSTRACT

The disclosure relates to an optical system assembly for a camera device adapted to be used in a variable temperature environment, the optical system assembly comprising: at least two lenses, a lens barrel, having an inner side, configured to accommodate the at least two lenses, wherein the lens barrel comprises and/or consists of: a first opening and a second opening, at least two lens slots arranged at the inner side of the lens barrel to accommodate the at least two lenses, and at least one spacer spring configured within the lens barrel to allow distribution and/or compensation of stress and/or force caused due to a thermal compression and/or a thermal expansion of the lens barrel under variable temperature.

### CROSS-REFERENCE TO RELATED APPLICATIONS

This application claims priority to German Patent Application No. DE 10 2023 102 338.1, filed on Jan. 31, 2023, and German Patent Application No. DE 10 2023 108 100.4, filed on Mar. 30, 2023, both of which are incorporated herein by reference for all purposes.

### FIELD

The disclosure relates to an optical assembly. More particularly, the disclosure relates to an optical assembly to be used in a camera device for capturing a static or a dynamic scenery. The disclosure further relates to the optical assembly capable of being used in a wide range of temperature environment.

### BACKGROUND

Typical optical systems used in camera devices are configured with image processing modules to adapt to a lighting condition in order to obtain and deliver a consistent output image or video; however, there are special designing needs required to be taken care in order to cater to physical environmental conditions. For example, the weather may be hot, cold, moist, dusty, humid, rainy, etc. and there is possibility of environmental impact on performance of the hardware, software and electronics contained within the camera system. Therefore, it is a design and insulation requirements which requires to be taken care while configuring and designing the camera systems or the optical systems of the camera device.

Modern camera devices are capable of withstanding various environmental conditions such as dust, mud, water etc. by making the chamber of the camera device dust proof, water proof etc. such that the internal components of the camera systems are not impacted and the device is operable in a variety of environmental conditions.

The modern camera device primarily includes a plurality of lenses, a lens barrel, one or more sensors, and a printed circuit board, and a housing unit to accommodate said components. The lenses are accommodated within the lens barrel in one or more slots depending on the number of lenses used in a specific arrangement. Generally, the lenses are securely snap-fitted into one more slot within the lens barrel in a secured such that the lens do not rattle or come out of the slots in case of shock, vibrations etc. However, under certain thermal environmental conditions such an excessive heat or cold, the material used to make the lens barrel and indeed the slots experience thermal expansion and thermal compression respectively. In such an event, the lens may either loosen up and/or exert pressure in the nearby region, thereby causing the lens to fall out from the slot or break due to stress produced in said region.

U.S. Pat. No. 10,928,606 B2 (US'606) patent, disclosed a lens unit comprising a spacer ring which absorbs compression forces due to the thermal expansion of the lenses. The lens assembly can also be adapted to be used with a vehicle. However, the US'606 does not discloses maintaining a pretension constant and at the same time involve a complicated spacer structure which consists of multiple spacer space offset to each other in order to cancel the resultant force thereby making the spacer structure less effective during variations in force lines. Therefore, the withstanding capacity along a line may impact the structural rigidity of the counterpart space of the spacer.

JP 6 054 819 B2 (JP'819) patent discloses use of an elastic member as spacer between two lenses so as to prevent backlash in case of temperature change. However, the elastic member disclosed in the JP'819 patent tends to add structural limitations thereby causing increase in cost and overall packaging.

U.S. Pat. No. 9,658,423 B2 (US'423) patent discloses a springless lens assembly comprising a thermal spacer which compensates for defocus of lens assembly due to thermal expansion. The length of the spacer changes according to the temperature changes and it moves the inner barrel and outer barrel of the lens assembly to move the focus point. However, the lens assembly of US'423 patent does not allow to compensate structural deformation due to thermal expansion or contraction and/or to avoid damage to the inner parts of the assembly.

That being said, none of the aforementioned prior arts discloses an optical system assembly allowing to avoid stresses to its optical elements, in particular lenses, due to a contraction or expansion caused by thermal expansion or thermal contraction of a supporting structure of the assembly in a cost wise and construction wise efficient manner.

### SUMMARY

The present disclosure provides an optical system assembly for a camera device adapted to be used in a variable temperature environment, the optical system comprising:
at least two lenses; and a lens barrel, having an inner side configured to accommodate the at least two lenses, wherein the lens barrel comprises and/or consists of: a first opening and a second opening, at least two lens slots arranged at the inner side of the lens barrel to accommodate the at least two lenses, wherein at least one spacer spring configured within the lens barrel to allow distribution and/or compensation of stress and/or force caused due to a thermal compression and/or a thermal expansion of the lens barrel under variable temperature.

It is furthermore proposed that in an embodiment
the assembly comprises a plurality of lenses,
the barrel has an outer side,
the barrel comprises a plurality of lens slots spread across the inner side, the first opening and the second opening, and/or
the spacer spring is configured to adapt its longitudinal extension along a longitudinal axis between the first opening and the second opening within the lens barrel.

In an embodiment, the lenses include at least one concave lens, at least one convex lens and/or a combination of a concave lens and a convex lens.

In another embodiment, the lens barrel comprises and/or is made up of material including at least one metal, at least one alloy, and/or at least one polymer.

In another embodiment, the lens barrel is and/or comprises an assembly of at least one, optionally a plurality of, cylindrical barrel piece(s), at least one, optionally a plurality of, spacer member(s) and/or at least one, optionally a plurality of, sealing member(s).

In another embodiment, the lens barrel further comprises a first retainer and a second retainer, optionally to sandwich the lenses, the cylindrical piece(s), the spacer member(s), and/or the sealing member(s), together.

In another embodiment, the first retainer and the second retainer are fastened and/or screwed to the cylindrical piece(s), the spacer member(s), and/or the sealing member(s) by one or more fastener(s).

In another embodiment, the lenses, the cylindrical piece(s) and/or the spacer spring(s) are axially arranged, in particular in a barrel form, in one or more combinations to form the optical system assembly.

In another embodiment, the spacer spring is configured in-between one of the at least two lenses, at least two cylindrical barrel pieces, or a combination of a lens and a cylindrical piece.

In another embodiment, the first opening and/or the second opening is/are circular in shape.

In another embodiment, the first opening is configured to allow a light beam to enter the lens barrel, exit through the second opening and/or being received by at least one photo receptor.

In another embodiment, the first opening and the second opening have one of a similar diameter or a different diameter.

In another embodiment, each of the lenses has a lens thickness.

In another embodiment, the lens thickness for each of the lenses is one of same or different with respect to at least one of the other lenses and/or each other and/or the lens thickness of at least one pair of lenses is same or different.

In another embodiment, each of the plurality of lens slots has a slot thickness.

In another embodiment, the slot thickness for each of the plurality of lens slots is one of same or different with respect to at least one of the lens slots and/or each other and/or the slot thickness of at least one pair of lens slots is same or different.

In another embodiment, at least one, optionally each, of the plurality of lens slots is configured with a thickness same as that of the thickness of the corresponding lens, amongst the plurality of lenses, preferably to avoid any rattling or loose fitting of the at least one lens, optionally each of the lens, within the corresponding lens slot, optionally each of the corresponding lens slots.

In another embodiment, the spacer spring has at least partly a cylindrical shape and/or has at least one groove, at least one step and/or at least one cut out, preferably running at least partly along an outer surface of the spacer spring, optionally around a circumferential direction.

For the before described embodiment it is proposed that the groove, the step and/or the cut-out is/are formed in a, optionally single-piece, wall, in particular comprising the outer surface, of the spacer spring, wherein optionally the wall is mainly extending in a direction parallel to a longitudinal axis extending from the first opening to the second opening and/or the groove and/or the step is with respect to the longitudinal axis inwardly extending from the wall or is with respect to the longitudinal axis radially outwardly extending from the wall.

It is also proposed that in an embodiment the groove and/or the step has/have a first sidewall being at least partly inclined with respect to the wall of the spacer spring and/or the groove has a second sidewall being at least partly inclined with respect to the wall of the spacer spring.

Furthermore in the optical system assembly it is proposed that in an embodiment the first sidewall and the second sidewall are directly connected or the first sidewall and the second sidewall are connected via at least one groove bottom, wherein the groove bottom is optionally at least partly extending parallel to the longitudinal axis.

In another embodiment the first sidewall, the second side wall and/or the groove bottom is/are at least partly curved, optionally the first sidewall, the second side wall and/or the groove bottom form at least one single, in particular single-piece, curved wall element.

In another embodiment, the groove and/or the step of the spacer spring has/have a thickness and/or form configured such that to absorb any stress and/or force caused by the thermal deformation, and/or one of a thermal compression expansion or a thermal expansion of the cylindrical pieces along a stress line, in particular a stress line (SL) at least partly extending mainly parallel to the longitudinal axis.

Furthermore it is proposed that, in an embodiment, by a stress and/or force acting on the spacer spring, in particular along the stress line,
(i) a relative angle between the first sidewall and the second sidewall is, in particular elastically, changed and/or
(ii) a relative angle between the first sidewall and the groove bottom or a relative angle between the first sidewall and the wall, is, in particular elastically, changed and/or
(iii) a relative angle between the second sidewall and the groove bottom or a relative angle between the second sidewall and the wall is, in particular elastically, changed, and/or
(iv) a curvature of the first sidewall, the second side wall, the bottom groove and/or the curved wall element is, in particular elastically, changed.

It is also proposed that in an embodiment a plurality of cut-outs is provided, wherein preferably the cut-outs are connected by bars and/or bars are located between the cut-outs, wherein optionally the cut-outs and/or the bars have a form and/or dimensions configured to absorb any stress and/or force caused by the thermal deformation, and/or one of a thermal compression expansion or a thermal expansion, of the cylindrical pieces along a stress line, in particular a stress line at least partly extending mainly parallel to the longitudinal axis.

For the before described embodiment it is proposed that the cut-outs and/or bars are configured to absorb stress and/or force by a, in particular elastic, deformation at least a part of the cut-outs and/or at least a part of the bars.

In another embodiment, the stress line is at least partly defined by connecting points of the plurality of cylindrical pieces, the spacer member, and/or the sealing member.

In another embodiment, the optical system assembly is adapted to be used with a camera unit of a vehicle. However, various embodiments are possible in which the optical system assembly may be mounted separately on the vehicle. In other possible embodiments, the optical system assembly may be used in non-vehicular systems as well.

In another embodiment, the at least one lens is provided with a protrusion for detachably attaching to the optical system assembly. Thus, the assembly process can be easy and fast.

### BRIEF DESCRIPTION OF THE DRAWINGS

Other aspects, advantages, and salient features of the present disclosure will become apparent to those skilled in the art from the following detailed description, which taken in conjunction with the annexed figures, discloses exemplary embodiments of the disclosure, wherein:

FIG. 1: illustrates an isometric view and an optical system assembly according to an embodiment of the present disclosure;

FIG. 2: illustrates an exploded view and the optical system assembly according to an embodiment of the present disclosure;

FIG. 3: illustrates a cross-sectional view of the optical system assembly an optical system assembly according to an embodiment of the present disclosure;

FIG. 4a-4d: illustrates the isometric views and the cross-sectional views of a spacer spring of the optical system assembly according to various embodiments of the present disclosure;

FIG. 5a-5d: illustrate cross-sectional views of a spacer spring of the optical system assembly according to an alternative embodiment of the present disclosure;

illustrate cross-sectional views of a spacer spring of the optical system assembly according to a further alternative embodiment of the present disclosure; and

FIG. 6a-6b FIG. 7a illustrates a perspective view onto a spacer spring of the optical system assembly according to a further alternative embodiment of the present disclosure;

FIG. 7b illustrates a view onto the spacer spring of FIG. 7a in the direction D₁: and

FIG. 7c-7d illustrate views onto the spacer spring of FIG. 7a in the direction D₂.

### DETAILED DESCRIPTION

It is to be understood that the embodiments described are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The term “vehicle” denotes any motor driven vehicle with or without trailers driven by a driver, where the driver requires information about persons, other vehicles or objects in the (near) surrounding of the vehicle to be able to drive safety. As an example, vehicles are cars, trucks, tractors or trailers.

The term “rear view” is herein referred as a view of the surrounding area, which is not in the field of view of a driver, i.e. the directions opposing, left, right, below and above of the viewing direction, but can also comprise the view in the direction of the viewing direction of the driver and/or any combinations of the directions.

The term “lens” is defined as a transmissive optical device that focuses or disperses a light beam by means of refraction. In general, a simple lens consists of a single piece of transparent material, while a compound lens consists of several simple lenses (elements), usually arranged along a common axis. Lenses are made from materials such as glass or plastic and are ground, polished, or molded to the required shape. The lens can focus light to form an image.

The term “camera device” is defined is an optical system that captures images aligned or integrated by one or more lenses. Most cameras can capture 2D images, while some more advanced models can capture 3D images. In general, the camera consists of a sealed box, with a small hole, called the aperture, that allows light to pass through and capture an image on a photo receptor or a light/photo-sensitive surface. The photo receptors are usually a digital sensor or a photographic film. The cameras may have various mechanisms to control the light falling onto the photo receptor, including lenses that focus the light and a shutter that determines the amount of time the photo receptor is exposed to the light beam.

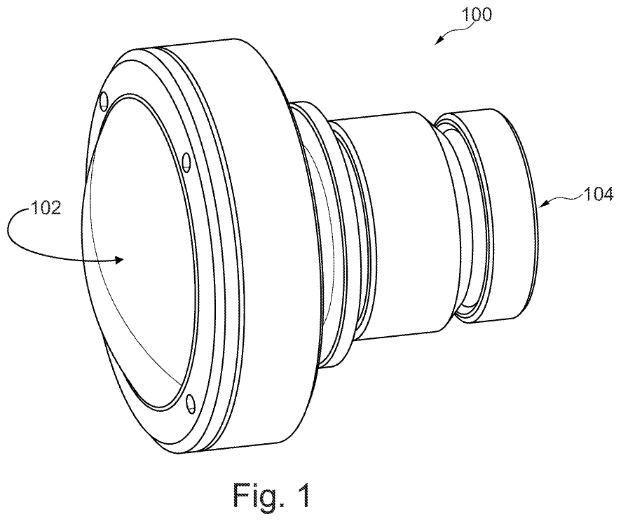

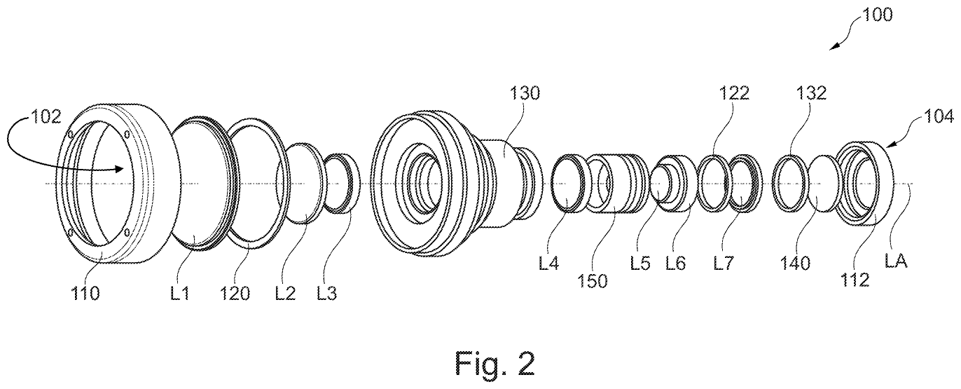

As illustrated in FIGS. 1 and 2, disclosed herein is an optical system assembly 100 for a camera device (not shown) according to an embodiment of the present disclosure. The optical system assembly 100 is adapted to be used in a variable temperature environment. The optical system assembly 100 comprises a plurality of lenses L1-L7, a lens barrel (in particular the optical system assembly 100 including at least a part or all of its herein described elements, such as cylindrical pieces, spacer member(s), retainer(s), fastener(s) and scaling member(s), without the plurality of lenses), and a spacer spring 150. The plurality of lenses include a first lens L1, a second lens L2, a third lens L3, a fourth lens L4, a fifth lens L5, a sixth lens L6 and a seventh lens L7.

The plurality of lenses L1-L7, as used hereinabove, is disposed within the lens barrel along a single axis, in particular a longitudinal axis LA. The plurality of lenses L1-L7 include but not limited to a concave lens, a convex lens and/or a combination thereof. Further, each of the plurality of lenses L1-L7 has a thickness pre-decided on the basis of a dedicated lens slot in order to have a proper fit without creating any rattle. The plurality of lenses L1-L7 focus or disperse a light beam (not shown) before facing one or more photo receptor. The plurality of lenses L1-L7 are made of materials including but not limited to glass and plastic.

The lens barrel, as used herein above, has an inner side IS and an outer side OS. Further, the lens barrel comprises a first opening 102 and a second opening 104 in order to allow the light to enter and exit. Furthermore, the lens barrel is configured to accommodate the plurality of lenses L1-L7 with the help of one or more lens slots LS spread across the inner side IS of the lens barrel, from the first opening 102 to the second opening 104 of the lens barrel. The lens barrel is made up of material including at least one of a metal, an alloy, a polymer, and a combination thereof. The lens barrel is an assembly of at least one of a plurality of cylindrical pieces 130, 132, a spacer member 122 and/or a sealing member 120. In an embodiment, the first opening 102 and the second opening 104 have one of a similar diameter and a different diameter. Further, each of the plurality of (lens) slots LS and lens have a slot thickness and a lens thickness respectively. The slot thickness for each of the plurality of slots is one of same and different with respect to each other. Moreover, each of the plurality of lenses slots LS is configured with a thickness same as that of the thickness of the corresponding lens, amongst the plurality of lenses L1-L7, to avoid any rattling or loose fitting of each of the lens within each of the corresponding slot.

In an embodiment, the spacer member 122 in the lens barrel assembly is configured to maintain a sufficient distance between two lenses or to provide a preconfigured focal length for the light to refract. The spacer member 122 is made of material including but not limited to aluminium, iron, metal alloy, polymer etc.

Furthermore, the sealing member 120 is configured to provide a scaling to optical system assembly 100 by creating a dust and/or water-resistant chamber. Additionally, the lens barrel includes an infrared filter 140. In an embodiment, the lens barrel comprises a first retainer 110 and a second retainer 112 to sandwich the plurality of lenses L1-L7 and the plurality of cylindrical pieces 130, 132, the spacer member 122, the sealing member 120 and the infrared filter 140 together. The infrared filter 140 can be replaced with any other filter to a desired image.

The spacer spring 150, as used hereinabove, is configured within the lens barrel to allow distribution of stress and/or force, developed in a stress line SL, caused due to one of a thermal compression and a thermal expansion of the lens barrel under variable temperature. The stress line SL is defined by connecting points of the plurality of cylindrical pieces 130, 132 and at least partly runs parallel to the longitudinal axis LA. The plurality of lenses L1-L7, the plurality of cylindrical pieces 130, 132 and the spacer spring 150 are axially arranged, in a barrel form, in one or more combinations to form the optical system assembly 100. The spacer spring 150 is configured in-between one of at least two lenses, at least two cylindrical pieces 130, 132, and a combination of a lens (any of L1-L7) and a cylindrical piece (any of 130, 132). The spacer spring 150 has a cylindrical shape having at least one groove 152 in a, optionally single-piece, wall of the spacer spring. The wall at least partly runs mainly parallel to the longitudinal axis LA. The groove 152 is running along an outer surface of the spacer spring, in particular an outer surface of the wall of the spacer spring 150 around a circumferential direction. The at least one groove 152 of the spacer spring 150 has a thickness configured to absorb any stress and/or force caused by the thermal deformation, and/or one of a thermal compression expansion or a thermal expansion, of the barrel and/or cylindrical pieces 130, 132 along a stress line SL.

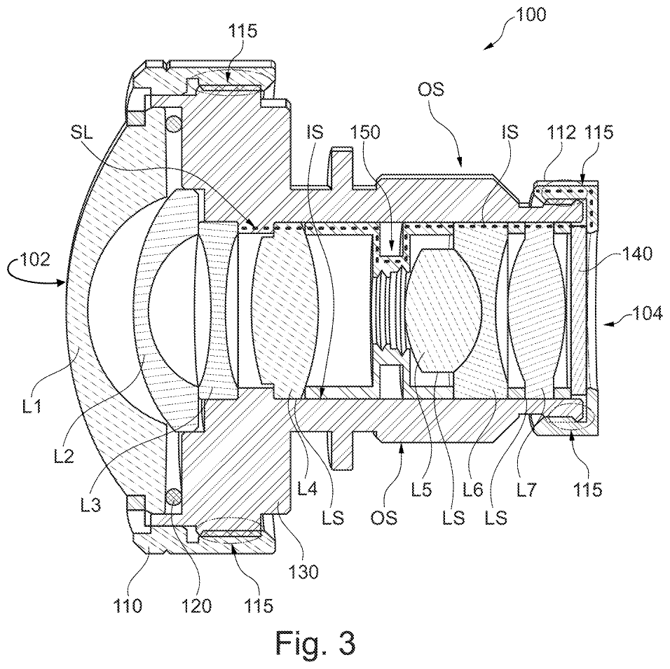

As illustrated in FIG. 3, disclosed herein is a cross-sectional view of the optical system assembly 100 according to an embodiment of the present disclosure. The optical system assembly 100 comprises the plurality lenses, lens barrel and the spacer spring 150, all stacked in barrel shape. The lens barrel has a plurality of cylindrical pieces 130, 132, the spacer member 122 and the sealing member 120. The lens slots LS and the corresponding lens have a corresponding thickness, in particular to have a proper fit such that no rattling or misfit occurs. Further, as illustrated in FIGS. 1 and 2, the plurality of cylindrical pieces 130, 132, the spacer member 122, the scaling member 120, and the spacer spring 150 of the optical system assembly 100 are stacked together by the first retainer 110 and the second retainer 112. The first retainer 110 and the second retainer 112 are also fastened to one of the plurality of cylindrical pieces 130, 132, the spacer member 122, the sealing member 120, and the, optionally single-piece, spacer spring 150 by at least one fastener 115, as illustrated in FIG. 3. After fastening and forming the optical system assembly 100, a stress line SL is developed which eventually holds the plurality of lenses L1-L7, lens barrel (100 without the Plurality of lenses) and the spacer spring 150 together. A part of the stress line (SL) runs mainly parallel to the longitudinal axis (LA). Due to thermal compression and/or thermal expansion caused by a change in temperature beyond an ideal temperature, there is a change in stress and/or force along the stress line SL; however, due to the spacer spring 150, change in stress along the stress line SL is absorbed or nullified and therefore maintaining a pre-tension.

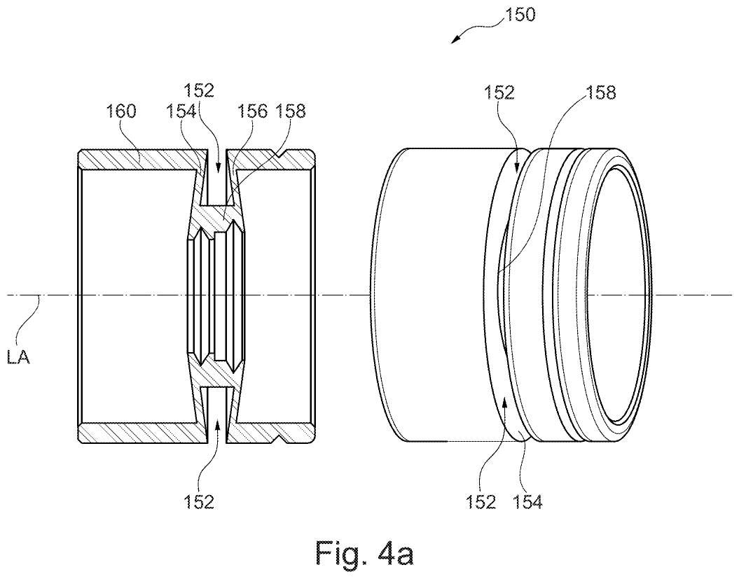

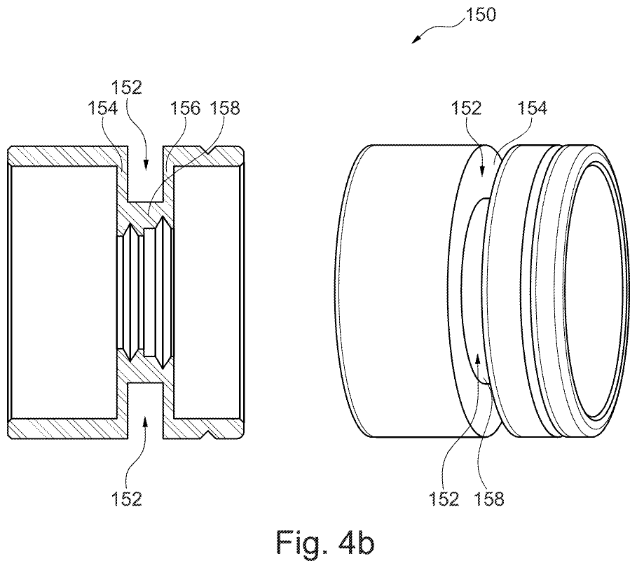

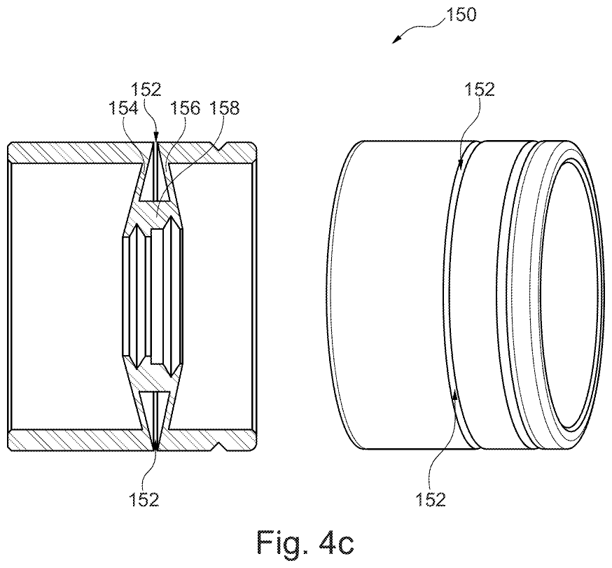

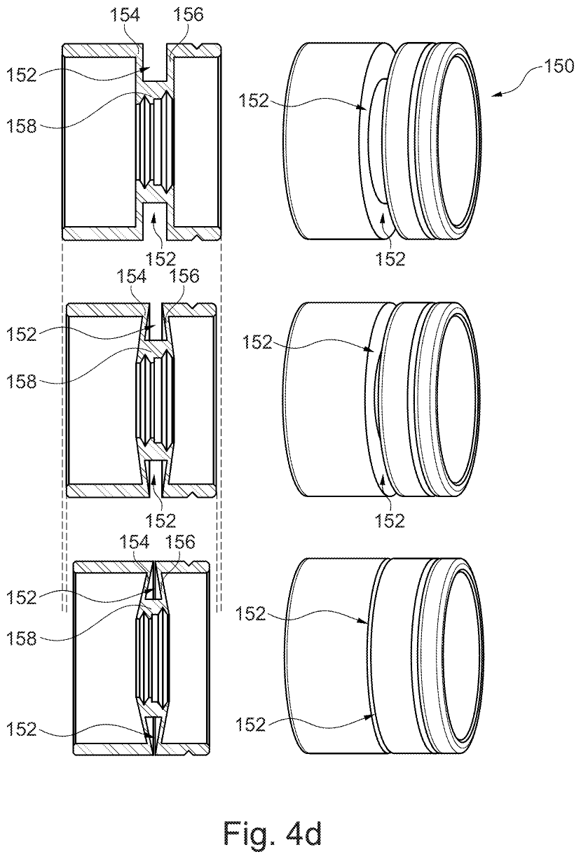

In an embodiment, as illustrated in FIGS. 4a and 4d, disclosed herein is the spacer spring 150 with the groove 152 having a thickness at the ideal temperature range. As shown in FIG. 4a the groove 152 is inwardly extending into the spacer spring 150, in particular in a direction to the longitudinal axis (LA) has a first sidewall 154 and a second sidewall 156. Via a groove bottom 158 the first sidewall 154 and the second sidewall 156 are connected to each other. The first sidewall 154 and the second sidewall 156 are inclined relative to a wall 160 of the spacer spring 150 and the groove bottom 158, that is optionally extending parallel to the longitudinal axis LA, is located at the ends of the sidewalls 154, 156 being located opposite the ends of the sidewalls 154, 156 connected to the wall 160. Optionally the spacer spring 150, the first sidewall 154, the second sidewall 156, the groove bottom 158 and/or the wall 160 is/are formed as a single piece.

In an event, the optical system assembly 100 is exposed to a temperature above the ideal temperature range, the thickness of the grove 152 increases due to the thermal expansion of the plurality of cylindrical pieces, spacer member 122 etc. along the stress line SL, as illustrated in FIGS. 4b and 4d, thereby maintaining the same stress/pre-tension along the stress line SL as a result there is no loosening of the components within the lens barrel, and especially the plurality of lenses L1-L7 doesn't fall out or loose from the lens slots LS. Alternatively when the optical system assembly 100 is exposed to a temperature below the ideal temperature range, the thickness of the grove 152 increases due to the thermal compression of the plurality of cylindrical pieces, spacer member 122 etc. along the stress line SL, as illustrated in FIGS. 4b and 4d, thereby maintaining the same stress/pre-tension along the stress line SL as a result there is no loosening of the components within the lens barrel, and especially the plurality of lenses L1-L7 doesn't fall out or loose from the lens slots LS. The change of the thickness of the groove is in particular reached by a change in the relative inclination of the sidewalls 154, 156 with respect to each other. In FIG. 4a the sidewalls 154, 156 have a first relative angle being greater than the second relative angle shown in FIG. 4b being mainly zero degree, i.e. in FIG. 4b the first sidewall 154 and 156 are mainly parallel to each other, optionally extending perpendicular to the longitudinal axis LA. In particular the angle between the first sidewall 154 and/or the second sidewall 156 on the one hand and the bottom groove 158 is less than 90 degrees in the situation shown in FIG. 4a compared to about 90 degrees in the situation shown in FIG. 4b.

Further, in an event, the optical system assembly 100 is exposed to a temperature below the ideal temperature range, the thickness of the grove 152 decreases due to the thermal compression of the plurality of cylindrical prices, spacer member 122 etc. along the stress line SL, as illustrated in FIGS. 4c and 4d, thereby maintaining the same stress along the stress line SL as a result there is no force exerted on the components within the lens barrel, and especially no stress is caused to the plurality of lenses L1-L7 at the lens slots avoiding chances of any damage to the plurality of lenses L1-L7. Alternatively, when the optical system assembly 100 is exposed to a temperature above the ideal temperature range, the thickness of the grove 152 decreases due to the thermal expansion of the plurality of cylindrical pieces, spacer member 122 etc. along the stress line SL, as illustrated in FIGS. 4c and 4d, thereby maintaining the same stress along the stress line SL as a result there is no force exerted on the components within the lens barrel, and especially no stress is caused to the plurality of lenses L1-L7 at the lens slots avoiding chances of any damage to the plurality of lenses L1-L7. In other words the relative angle between the first sidewall 154 and the second sidewall 156 as well as a relative angle between the first sidewall 154 and the second sidewall 156 on the one hand and the groove bottom 158, has increased in the situation shown in FIG. 4c compared to the situation shown in FIG. 4a. Also, the absorption of stress at the spacer spring 150 allows the lenses L1-L7 to be in the same location during expansion or compression which may avoid the requirement of adjusting the focal lengths for multiple lenses L1-L7. In particular the position of the lens L5 remains unchanged as the groove bottom 158 to which the lens L5 abuts does not change its form.

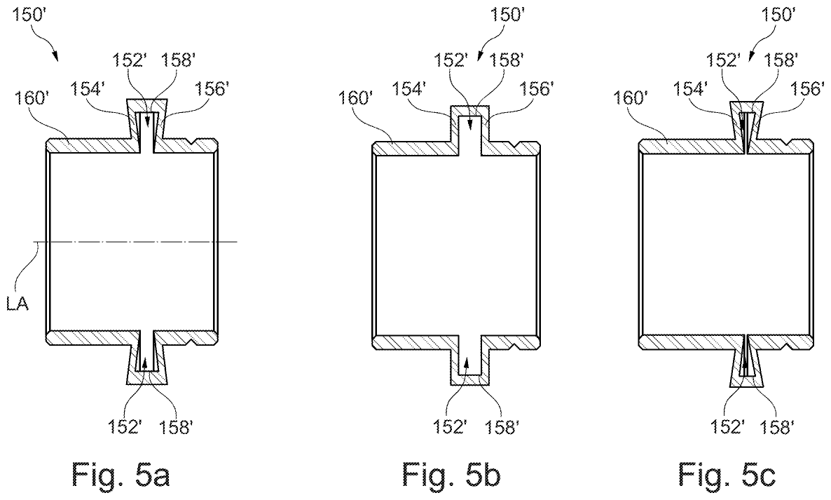

In an embodiment, as illustrated in FIGS. 5a to 5c, a spacer spring 150′ might have a groove 152′ that is outwardly extending. Elements of the spacer spring 150′ corresponding to respective elements of the spacer spring 150 have the same reference signs, however with one apostrophe. As shown in FIG. 5a the groove 152′ is outwardly extending out of the wall 160′ of the spacer spring 150′, in particular in a direction away from the longitudinal axis (LA′). The spacer spring 150′ has a first sidewall 154′ and a second sidewall 156′. Via a groove bottom 158′, that is optionally extending parallel to the longitudinal axis LA′, the first sidewall 154′ and the second sidewall 156′ are connected to each other. The first sidewall 154′ and the second sidewall 156′ are, as shown in FIG. 5a, inclined relative to a wall 160′ of the spacer spring 150′ and the groove bottom 158′ is located at the ends of the sidewalls 154′, 156′ being located opposite the ends of the sidewalls 154′, 156′ connected to the wall 160′. Optionally the spacer spring 150′, first sidewall 154′, the second sidewall 156′, the groove bottom 158′ and/or the wall 160′ is/are formed as a single piece.

In an event, the optical system assembly incorporating spacer spring 150′ is exposed to a temperature below the ideal temperature range, the thickness of the grove 152′ increases as illustrated in FIG. 5b. The change of the thickness of the groove 152′ is in particular reached by a change in the relative inclination of the sidewalls 154′, 156′ with respect to each other. In FIG. 5a the sidewalls 154′, 156′ have a first relative angle being greater than the second relative angle shown in FIG. 5b being mainly zero degree, i.e. in FIG. 5b the first sidewall 154′ and second sidewall 156′ are mainly parallel to each other, optionally extending perpendicular to the longitudinal axis LA′. In particular the angle between the first sidewall 154′ and/or the second sidewall 156′ on the one hand and the bottom groove 158′ is less than 90 degrees in the situation shown in FIG. 5a compared to about 90 degrees in the situation shown in FIG. 5b.

Further, in an event, the optical system assembly including the spacer spring 150′ is exposed to a temperature above the ideal temperature range, the thickness of the grove 152′ decreases as illustrated in FIG. 5c. In other words the relative angle between the first sidewall 154′ and the second sidewall 156′ as well as a relative angle between the first sidewall 154′ and the second sidewall 156′ on the one hand and the groove bottom 158′, has increased in the situation shown in FIG. 5c compared to the situation shown in FIG. 5a.

Although in the specific embodiment of FIGS. 1 to 4d the spacer spring 150 having an inwardly extending groove 152 has been described, it has to be understood that the groove might also be outwardly extending and fulfilling the same functionality as described before for spacer spring 150′ shown in FIGS. 5a to 5c. Furthermore the claimed subject matter is not restricted to a groove having straight wall elements. At least one of the sidewalls 154, 156 and/or the bottom groove 158 might be at least partly curved and/or the complete groove might be formed by a single curved wall element. The change of the thickness of the groove might than be reached by a change of the curvature.

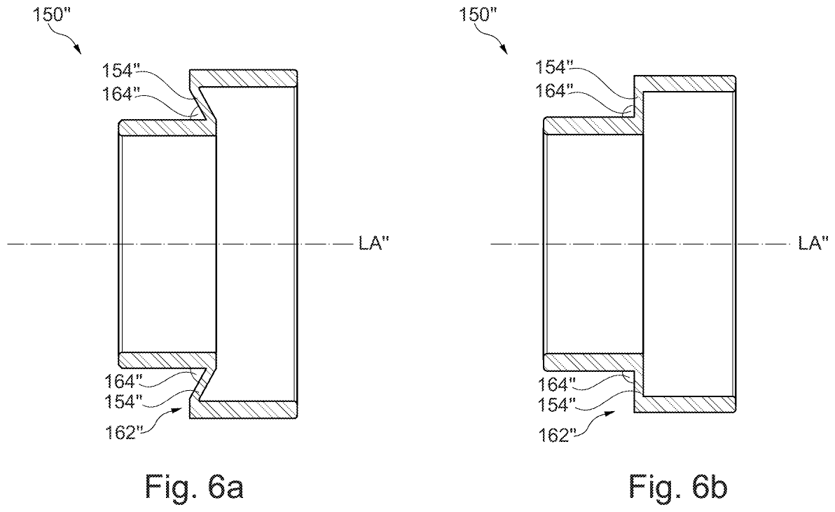

In FIGS. 6a and 6b a further embodiment of a spacer spring 150″ is shown. Elements of the spacer spring 150″ corresponding to respective elements of the spacer spring 150 have the same reference signs, however with two apostrophes. As shown in FIG. 6a instead of a groove the spacer spring 150″ comprises a step 162″ that is outwardly extending out of the spacer spring 150″. In particular a first sidewall 154″ of the step 162″ is extending into a direction away from the longitudinal axis (LA″). The first sidewall 154″ is inclined relative to the wall 160″ of the spacer spring 150″ as shown in FIG. 6a, in particular when the spacer spring 150″ is exposed to an ideal temperature. Optionally the spacer spring 150″, first sidewall 154″, the wall 160″, and/or the step 162″ is/are formed as a single piece.

In an event, the optical system assembly in which the spacer spring 150″ is located is exposed to a temperature below the ideal temperature range, the length of the spacer spring 150″ along the longitudinal axis LA″ increases due to the thermal compression of the plurality of cylindrical pieces, spacer member etc. along the stress line SL, as illustrated in FIG. 6b, thereby maintaining the same stress/pre-tension along the stress line SL as a result there is no loosening of the components within the lens barrel, and especially the plurality of lenses L1-L7 doesn't fall out or loose from the lens slots LS. In FIG. 6a the sidewall 154″ has a first relative angle 164″ to the wall 160″ being less than 90 degrees whereas the relative angle has increased to 90 degrees in the situation shown in FIG. 6b in which optionally the sidewall 154″ extends perpendicular to the longitudinal axis −LA″.

In an event, the optical system assembly in which the spacer spring 150″ is located is exposed to a temperature above the ideal temperature range, the length of the spacer spring 150″ along the longitudinal axis LA″ decreases due to the thermal expansion of the plurality of cylindrical pieces, spacer member etc. along the stress line SL thereby maintaining the same stress/pre-tension along the stress line SL as a result there is no loosening of the components within the lens barrel, and especially the plurality of lenses L1-L7 doesn't fall out or loose from the lens slots LS. Compared to FIG. 6a the sidewall 154″ will have first relative angle to the wall 160″ being even smaller than the relative angle 164″ shown in FIG. 6a.

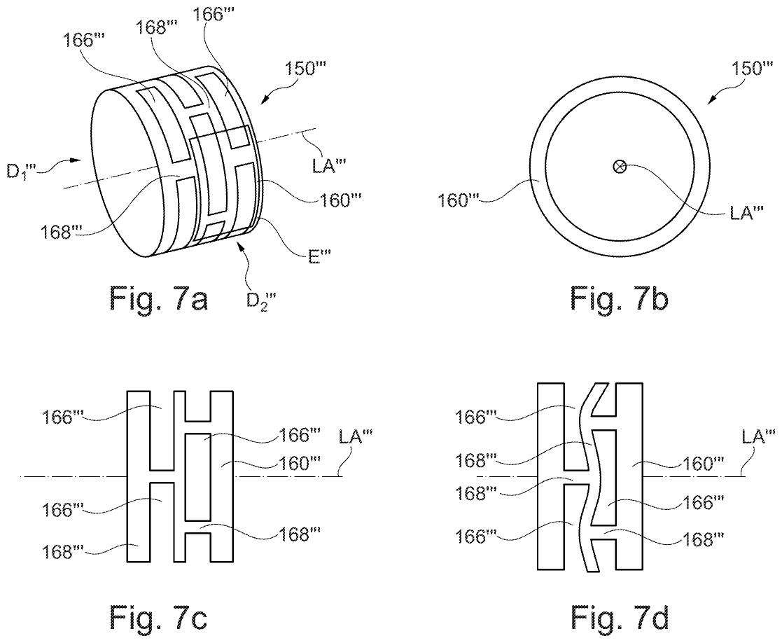

In FIGS. 7a to 7d a further embodiment of a spacer spring 150′″ is shown. Elements of the spacer spring 150′″ corresponding to respective elements of the spacer spring 150 have the same reference signs, however with three apostrophes.

As shown in FIG. 7a the wall 160′″ of the spacer spring 150′″ comprises a plurality of cut-outs 166′″. The cut-outs 166′″ are connected by bars 168′″ with each other or in other words bars 168′″ are located between the cut-outs 166′″.

In FIG. 7b a view onto the spacer spring 150′″ in the direction D₁′″ in FIG. 7a is shown.

In FIGS. 7c and 7d views from the direction D₂′″ in FIG. 7a onto the detail E′″ are shown. As can be taken from FIGS. 7c and 7d the cut-outs 166′″ and the bars 168′″ allow to absorb stresses and/or forces caused by a thermal deformation, and/or one of a thermal compression expansion or a thermal expansion, of the cylindrical pieces along a stress line (SL) comprised by an optical system assembly into which the spacer spring 150′″ is integrated. In FIG. 7d the spacer spring 150′″ is shown in a situation in which the temperature is increased compared to the situation shown in FIG. 7c. Due to the increased temperature the length of the spacer spring 150′″ along the longitudinal axis LA′″ has decreased from the situation shown in FIG. 7c to the situation shown in FIG. 7d. The decrease is caused by the thermal expansion of the plurality of cylindrical pieces, spacer member etc. along the stress line SL. The decrease is reached by a elastic deformation of the cut-outs 166′″ and at least a part of the bars 168′″.

In an embodiment of the present disclosure, the optical system assembly 100 is used with a camera device (not shown) of the vehicle (not shown). Further, the optical system assembly 100 is adapted to be used as a rear-view camera device (not shown) of the vehicle (not shown).

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims. I.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

### REFERENCE SIGNS

100 optical system assembly
102 first opening
104 second opening
110 first retainer
112 second retainer
115 fastener
L1 first lens
L2 second lens
L3 third lens
L4 fourth lens
L5 fifth lens
L6 sixth lens
L7 seventh lens
120 sealing member
122 spacer member
130 cylindrical piece
132 cylindrical piece
140 infrared filter
150, 150′, 150″ spacer spring
152, 152′ groove
154, 154′, 154″ sidewall
156, 156′ sidewall
158, 158′ groove bottom
160, 160′, 160″ wall
162″ step
164″ angle
166′″ cut-out
168″ bar
IS inner side
OS outer side
SL stress line
LS lens slot
LA, LA′, LA″, LA′″ longitudinal axis
D₁′″, D₂′″ Direction
E′″ Detail

It is claimed:

1. An optical system assembly for a camera device configured to be used in a variable temperature environment, the optical system assembly comprising:
at least two lenses;
a lens barrel, having an inner side, configured to accommodate the at least two lenses, wherein the lens barrel comprises:
a first opening and a second opening, and
at least two lens slots arranged at the inner side of the lens barrel to accommodate the at least two lenses; and
at least one spacer spring configured within the lens barrel to allow distribution and/or compensation of stress and/or force caused by a thermal compression and/or a thermal expansion of the lens barrel under variable temperature.

2. The optical system assembly according to claim 1, wherein
the assembly comprises a plurality of lenses,
the barrel has an outer side,
the barrel comprises a plurality of lens slots spread across the inner side, the first opening and the second opening, and/or
the spacer spring is configured to adapt its longitudinal extension along a longitudinal axis between the first opening and the second opening within the lens barrel.

3. The optical assembly according to claim 1, wherein the at least two lenses include at least one concave lens, at least one convex lens and/or a combination of at least one concave lens and at least one convex lens.

4. The optical system assembly according to claim 1, wherein the lens barrel comprises material including at least one metal, at least one alloy and/or at least one polymer.

5. The optical system assembly according to claim 1, wherein the lens barrel comprises an assembly of at least one cylindrical piece, at least one spacer member and/or at least one sealing member.

6. The optical system assembly according to claim 5, wherein the lens barrel further comprises a first retainer and a second retainer configured to sandwich the at least two lenses, the at least one cylindrical piece, the at least one spacer member, and/or the at least one sealing member, together.

7. The optical system assembly according to claim 6, wherein the first retainer and the second retainer are fastened and/or screwed to the at least one cylindrical piece, the at least one spacer member, and/or the at least one sealing member by one or more fasteners.

8. The optical system assembly according to claim 5, wherein the at least two lenses, the at least one cylindrical piece and/or the at least one spacer spring are axially arranged in a barrel form in one or more combinations to form the optical system assembly.

9. The optical system assembly according to claim 5, wherein the at least one spacer spring is configured in-between one of the at least two lenses, at least two cylindrical pieces, or a combination of a lens and a cylindrical piece.

10. The optical system assembly according to claim 1, wherein the first opening and/or the second opening is/are circular in shape.

11. The optical system assembly according to claim 1, wherein the first opening is configured to allow a light beam to enter the lens barrel, exit through the second opening and/or being received by at least one photo receptor.

12. The optical system assembly according to claim 1, wherein the first opening and the second opening have one of a similar diameter or a different diameter.

13. The optical system assembly according to claim 1, wherein each of the at least two lenses has a lens thickness.

14. The optical system assembly according to claim 13, wherein the lens thickness for each of the at least two lenses is one of same or different with respect to at least one other lens and/or each other and/or the lens thickness of at least one pair of lenses is same or different.

15. The optical system assembly according to claim 1, wherein each of the plurality of lens slots has a slot thickness.

16. The optical system assembly according to claim 15, wherein the slot thickness for each of the plurality of lens slots is one of same or different with respect to at least one of the lens slots and/or each other and/or the slot thickness of at least one pair of lens slots is same or different.

17. The optical system assembly according to claim 1, wherein at least one of the plurality of lens slots is configured with a thickness same as that of a thickness of a corresponding lens, amongst the at least two of lenses to avoid any rattling or loose fitting of the at least one lens within the corresponding lens slot.

18. The optical system assembly according to claim 1, wherein the at least one spacer spring has at least partly a cylindrical shape and/or has at least one groove, at least one step and/or at least one cut out, running at least partly along an outer surface of the at least one spacer spring.

19. The optical system assembly according to claim 18, wherein the groove, the step and/or the cut-out is/are formed in a wall comprising the outer surface of the at least one spacer spring, wherein the wall extends in a direction parallel to a longitudinal axis extending from the first opening to the second opening and/or the groove and/or the step is with respect to the longitudinal axis inwardly extending from the wall or is with respect to the longitudinal axis radially outwardly extending from the wall.

20. The optical system assembly according to claim 19, wherein the groove and/or the step has/have a first sidewall being at least partly inclined with respect to the wall of the spacer spring and/or the groove has a second sidewall being at least partly inclined with respect to the wall of the spacer spring.

21. The optical system assembly according to claim 20, wherein the first sidewall and the second sidewall are directly connected or the first sidewall and the second sidewall are connected via at least one groove bottom, wherein the groove bottom is at least partly extending parallel to the longitudinal axis and/or the first sidewall, the second sidewall and/or the groove bottom are formed as a single piece.

22. The optical system assembly according to claim 19, wherein the first sidewall, the second side wall and/or the groove bottom is/are at least partly curved, wherein the first sidewall, the second side wall and/or the groove bottom form at least one single, single-piece, curved wall element.

23. The optical system assembly according to claim 18, wherein the at least one groove and/or the step of the at least one spacer spring has/have a thickness and/or form configured to absorb any stress and/or force caused by the thermal deformation, and/or one of a thermal compression expansion or a thermal expansion, of the cylindrical pieces along a stress line at least partly extending at least substantially parallel to the longitudinal axis.

24. The optical system assembly according to claim 20, wherein by a stress and/or force acting on the at least one spacer spring along the stress line,
(i) a relative angle between the first sidewall and the second sidewall is elastically changed, and/or
(ii) a relative angle between the first sidewall and the groove bottom or a relative angle between the first sidewall and the wall is elastically changed, and/or
(iii) a relative angle between the second sidewall and the groove bottom or a relative angle between the second sidewall and the wall is elastically changed, and/or
(iv) a curvature of the first sidewall, the second side wall, the bottom groove and/or the curved wall element is elastically changed.

25. The optical system assembly according to claim 18, wherein a plurality of cut-outs is provided, wherein the cut-outs are connected by bars and/or the bars are located between the cut-outs, wherein the cut-outs and/or bars have a form and/or dimensions configured to absorb any stress and/or force caused by the thermal deformation, and/or one of a thermal compression expansion or a thermal expansion, of the cylindrical pieces along a stress line at least partly extending mainly parallel to the longitudinal axis.

26. The optical system assembly according to claim 25, wherein the cut-outs and/or bars are configured to absorb stress and/or force by an elastic deformation of at least a part of the cut-outs and/or at least a part of the bars.

27. The optical system assembly according to claim 23, wherein the stress line is at least partly defined by connecting points of the plurality of cylindrical pieces, the spacer member, and/or the sealing member.

28. The optical system assembly according to claim 1, wherein the optical system assembly is configured to be used with the camera device of a vehicle.
